(19) United States
(12) Patent Application Publication
(10) Pub. No.: US 2006/0095205 A1
(43) Pub. Date: May 4, 2006

(54) Navigation device

(75) Inventor: Seiji Ihara, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city, Aichi-pref. (JP)

(21) Appl. No.: 11/262,751

(22) Filed: Nov. 1, 2005

(30) Foreign Application Priority Data
Nov. 4, 2004 (JP) 2004-321151

(51) Int. Cl. G01C 21/36

(52) U.S. Cl. 701/211; 701/200; 701/208

(57) ABSTRACT

A user of an HDD navigation device inputs a first authentication key to the HDD navigation device. The HDD navigation device verifies the first authentication key with a second authentication key stored in the memory of the main body of the HDD navigation device. If the first and second authentication keys are identical, the HDD navigation device displays a screen for inputting a utilization period for which a corridor function is expected to be used. The user inputs the utilization period according to the screen. Then, the HDD navigation device gives information related to the utilization period in providing the corridor function.

### CROSS REFERENCE TO RELATED APPLICATION

This application is based on and incorporates herein by reference Japanese patent applications No. 2004-321151 filed on Nov. 4, 2004.

### FIELD OF THE INVENTION

The present invention relates to a navigation device.

### BACKGROUND OF THE INVENTION

Conventionally, navigation devices are proposed each of which has an external media drive for reading media such as CDs (Compact Disks) and DVDs (Digital Versatile Disks) and utilizes the external media drive for both a navigational function (specifically, a function for reading map data) and an audio function (specifically, a function for playing music or video), as described in JP-H2-151715 A and JP-H3-6773 A. When the external media drives in the documents are used for the audio function, the navigation devices provide the navigational function and the audio function simultaneously by reading, in advance, the map data through the external media drive, storing the map data to an internal memory, and using the map data in the internal memory for the navigational function.

Because of shortage in capacity of the internal memory, such a conventional corridor function for providing simultaneously the navigational function and the audio function may put a restriction on a performance of the navigation device for basic parts of the navigational function such as a map drawing function and a route guiding function, compared to a case that the navigation device directly reads the map data through the external media drive in providing the navigational function. Nevertheless, the corridor function is useful for the point that it can provide both the navigational function and the audio function simultaneously.

A high-capacity HDD (Hard Disk Drive) is incorporated in some conventional navigation devices (hereafter HDD navigation device). It has been conventionally supposed that the HDD navigation device can always read the map data stored in the HDD because the HDD is always incorporated in the HDD navigation device.

However, the HDD may be removed from the navigation device in order to modify the map data in the HDD. Therefore, in the technology field of the HDD navigation device, a growing emphasis is put on the corridor function for providing both the navigational function and the audio function simultaneously by utilizing the map data stored beforehand in the internal memory.

When the HDD navigation device provides the corridor function, it copies the map data from the HDD to the internal memory before the HDD is removed, and then utilizes the map data copied to the internal memory. In providing such an HDD corridor function, a problem arises as follows.

In using the conventional corridor function for the external media drive, the removed external media such as the CD or the DVD is likely put in a passenger compartment of a vehicle in which the navigation device is installed. Therefore, the corridor function for the external media drive can be deactivated quickly when necessary, by inserting the external media into the external media drive.

In contrast, in using the HDD corridor function, the removed HDD is likely took out of the passenger compartment. In this case, the HDD corridor function cannot be deactivated so quickly. As a result, a period for which the HDD corridor function is kept activated is possibly prolonged. Moreover, a restriction on the capacity of the internal memory possibly causes the restriction on the basic parts of the navigational function in the prolonged period.

As described above, in the HDD corridor function, the period for which the basic parts of the navigational function are restricted is possibly prolonged. This may make a user of the navigation device feel uncomfortable.

Even if another measure is made to cope with the removal of the HDD, the measure may make the user feel uncomfortable if it restricts the basic parts of the navigational function.

In addition, since it is possible to duplicate and falsify data in the HDD, the HDD corridor function may be abused for the purpose of the duplication and the falsification.

### SUMMARY OF THE INVENTION

It is therefore a first object of the present invention to avoid making the user of the HDD navigation device feel uncomfortable. It is a second object of the present invention to prevent the corridor function from being abused.

To achieve the above objects, a navigation device is provided with the following. A control means is included for providing a corridor function for reading data for navigation before removal of an HDD from the navigation device, storing the read data for the navigation to a memory in a main body of the navigation device, and using the data stored in the memory for the navigation after the removal of the HDD. A notification means is included for giving information related to a utilization period for which the corridor function is used.

By giving the information related to the utilization period for which the corridor function is used, the user can recognize that the corridor function is in operation. Therefore, even if the basic parts of the navigational function are restricted in the navigation device, the information psychologically eases inconvenience caused by the restriction. As a result, it is possible to avoid making the user feel uncomfortable.

In another aspect of the present invention, a navigation device is provided with the following. A main body is included. A certain HDD is included to be removable from the main body and to store data used for navigation. An installation determination means is included for determining a state of installation of the certain HDD to the main body. A code memorizing means is included for memorizing a first code for using an alternative HDD different from the certain HDD. A code determination means is included for determining whether the first code and a second code stored in the alternative HDD satisfy a predetermined condition. Here, data stored in the alternative HDD is used for the navigation when the first code and the second code are determined to satisfy the predetermined condition.

Since the certain HDD and the main body of the HDD navigation device are usually separable devices, the alternative HDD can be used for the navigation device while the certain HDD is removed. When the alternative HDD is installed to the navigation device, the codes are used for enabling use of the alternative HDD. Therefore, it can be avoided to use an unauthorized HDD because it is determined that a false code is stored in the unauthorized HDD.

It is possible to compose the data for the navigation and the second code by using software dedicated for their composition provided by a manufacturer of the navigation device. The manufacturer may distribute the software to the user when the user requests maintenance of the HDD.

In yet another aspect of the present invention, a navigation device is provided with the following. A control means is included for providing a corridor function for reading data for navigation before removal of an HDD from a main body of the navigation device, storing the read data for the navigation to a memory in the main body, and using the data stored in the memory for the navigation after the removal of the HDD. A key memorization means is included for memorizing a first authentication key for the corridor function. An input means is included for inputting a second authentication key when the corridor function is used. An authentication determination means is included for determining whether the first authentication key corresponds to the second authentication key. An instruction means is included for giving the control means an activating instruction that instructs the control means to activate the corridor function when the first authentication key is determined to correspond to the second authentication key. Here, the control means activates the corridor function when the activating instruction is given by the instruction means.

Thus, it is possible to prevent the corridor function from being abused for duplicating and falsifying, by activating the corridor function when the first key stored in advance corresponds to the second key input in using the corridor function.

### BRIEF DESCRIPTION OF THE DRAWINGS

The invention, together with additional objective, features and advantages thereof, will be best understood from the following description, the appended claims and the accompanying drawings. In the drawings:

FIG. 1 is a block diagram showing an HDD navigation device of an embodiment of the present invention;

FIG. 2 is a flowchart showing a memory use amount setting process;

FIG. 3 is a schematic view showing a memory use amount setting screen;

FIG. 4 is a flowchart showing a process executed when the navigation device is activated with its HDD removed;

FIG. 5 is a schematic view showing a menu screen when the HDD is not installed;

FIG. 6 is a flowchart showing an alternative HDD function process;

FIG. 7A is a schematic view showing a screen prompting a user to install the alternative HDD;

FIG. 7B is a schematic view showing a screen prompting the user to install the authorized HDD;

FIG. 8 is a flowchart showing a corridor function process;

FIG. 9A is a schematic view showing a screen for inputting an authentication key for using the corridor function;

FIG. 9B is a schematic view showing a screen for prompting the user to input an authentication key for using the corridor function;

FIG. 9C is a schematic view showing a screen for setting a utilization period for which the corridor function is used;

FIG. 10 is a flowchart showing process for a navigational function;

FIG. 11A is a schematic view showing a screen for notifying of deactivation of the corridor function; and

FIG. 11B is a schematic view showing a screen for indicating a remaining period before the end of the utilization period.

### DETAILED DESCRIPTION OF THE INVENTION

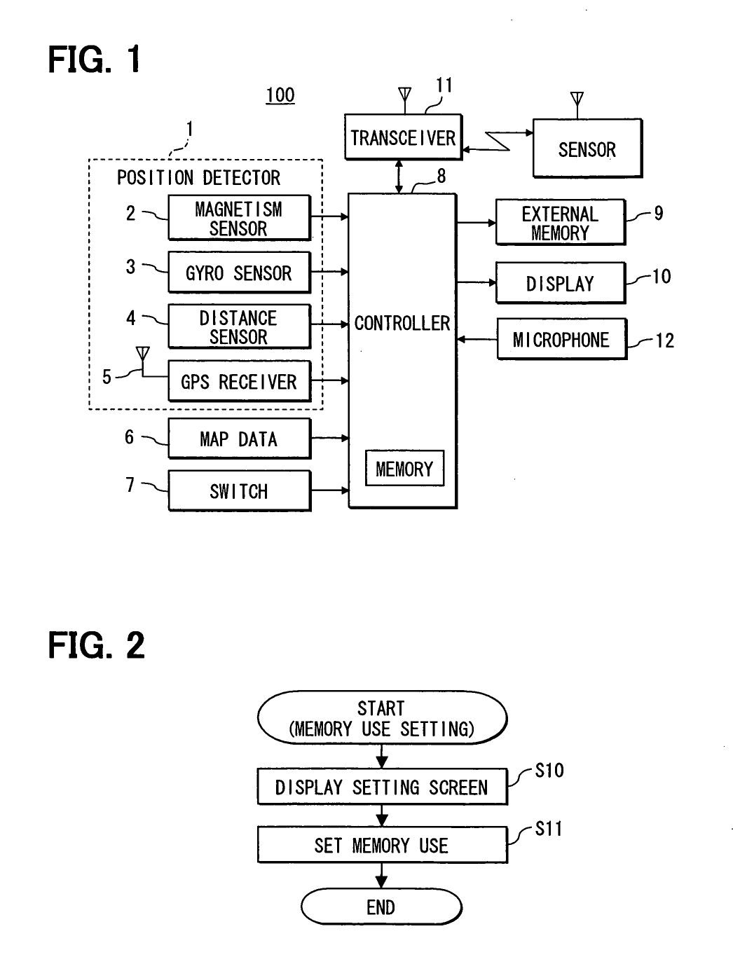

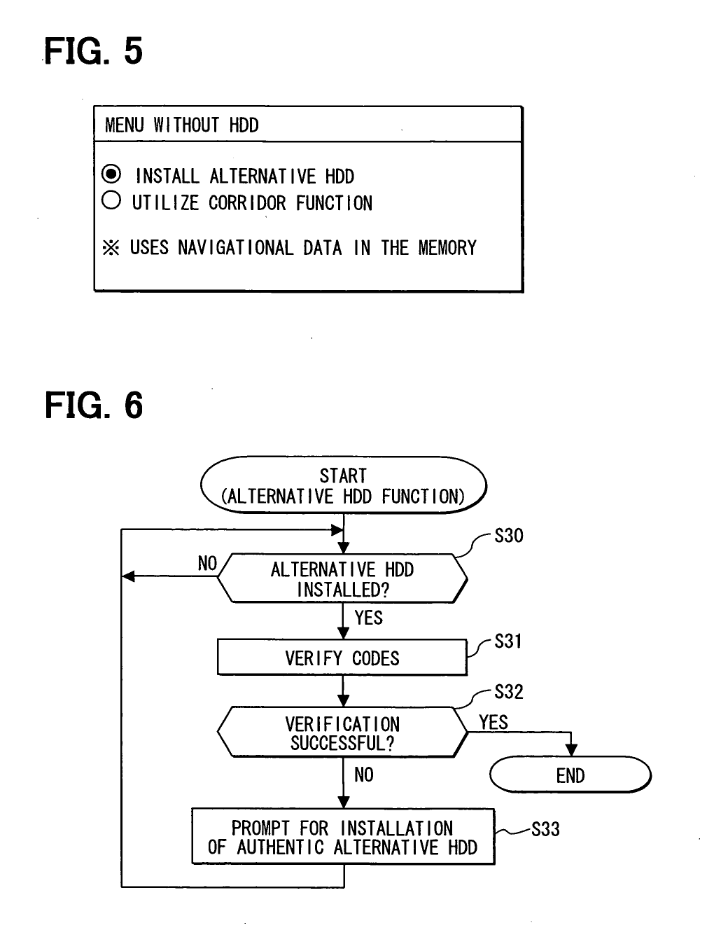

Hereafter, an HDD (Hard Disk Drive) navigation device in which an HDD is incorporated is described as an embodiment of the present invention with reference to FIGS. 1 to 11B. In this embodiment, the HDD navigation device is installed in a vehicle such as an automobile.

As shown in FIG. 1, the HDD navigation device 100 includes a position detector 1, a map data inputting device 6, operation switches 7, a controller 8, an external memory 9, a display 10, a transceiver 11, a microphone 12, a remote controller (not shown), and a remote command sensor (not shown).

The controller 8 is constructed as a microcomputer which includes a memory (e.g. a nonvolatile memory), a CPU, a ROM, a RAM, an I/O and a bus line which are well-known. The bus line connects the memory, the CPU, the ROM, the RAM, and the I/O with each other. Programs which the controller 8 executes are stored in the ROM, and the CPU or like executes predetermined calculation processes according to the programs. The memory in the controller 8 is commonly used by a corridor function and other functions executed by the HDD navigation device 100.

The position detector 1 includes an earth magnetism sensor 2, a gyro sensor 3, a distance sensor 4, and a GPS (Global Positioning System) receiver 5. The earth magnetism sensor 2 detects an azimuth angle of a heading direction of the vehicle. The gyro sensor 3 detects an angular velocity around a vertical axis of the vehicle. The distance sensor 4 detects a travel distance of the vehicle. The GPS receiver 5 detects position information indicating a current position of the vehicle and time information indicating a current date and time. The sensors 2 to 5 are used in a complementary style to compensate their detection errors originated by different causes.

The position detector 1 may be constituted by only a part of the sensors 2 to 5, if the part has sufficient detection accuracy. In addition, the position detector 1 may include a rotation sensor for detecting an amount of a rotation of a steering wheel of the vehicle and a velocity sensor detecting a velocity of the vehicle through rotational speeds of wheels of the vehicle.

The map data inputting device 6 is an HDD. The HDD 6 includes navigational data including road data, index data, and drawing data.

Since the HDD 6 and the controller 8 (or a main body of the HDD navigation device 100) are separable devices, the HDD 6 can be removed from the main body of the HDD navigation device 100. With the removed HDD 6, it is possible to give some maintenances such as an modification to the navigational data in the HDD 6 at a place outside of the vehicle and to copy several kinds of data to the HDD 6 from a PC (Personal Computer) in a home of a user of the vehicle.

The operation switches 7 include, for example, touch switches constructed together with the display 10 as a single body or mechanical switches and are used for several kinds of inputting.

The external memory 9 includes a readable and writable storage medium such as a memory card.

The display 10 is constructed by a liquid crystal display. The display 10 is capable of displaying, for example, a current vehicle position mark indicating the current position of the vehicle detected by the position detector 1 and a road map generated from the navigational data stored in the HDD 6.

The transceiver 11 is a transmitter and receiver to establish a connection for communications with an external device. For example, the transceiver 11 is connected with a VICS (Vehicle Information and Communication System; trademark) sensor receiving road traffic information supplied from a VICS center through a beacon constructed along a road and through an FM broadcast station.

The microphone 12 is used for inputting a voice from the user. A voice signal from the microphone 12 is converted to a digital signal by the controller 8. The controller 8 executes a voice inputting function for analyzing the digital signal and specifying words in the voice.

The HDD navigation device 100 provides, as basic functions for navigation (i.e., navigational functions), a map drawing function and a route guiding function. With the map drawing function, the HDD navigation device 100 displays a map including the current position and its surrounding area. With the route guidance function, the HDD navigation device 100 automatically finds a route from the current position to a destination on receiving an input of the destination through the remote controller and the remote command sensor (or the operation switches 7), and guides the user to the destination by displaying maps in accordance with progresses of the vehicle.

In addition, the HDD navigation device 100 provides several functions such as a facility searching function for searching facilities or an audio function for operating audio devices (not shown).

Next, the characteristic of the HDD navigation device 100 is described. The HDD navigation device 100 is capable of providing the navigational function even while the HDD 6 is removed from the main body in order to maintain the navigational data in the HDD 6 or to copy several kinds of data to the HDD 6 from the PC in a home of the user.

The first function for achieving the characteristic is an alternative HDD function for utilizing an alternative HDD to provide the navigational function after the removal of the original HDD 6.

The second function for achieving the characteristic is a corridor function for reading the navigational data before the removal of the HDD 6 from the main body, storing the navigational data to the memory in the controller 8, and utilizing the navigational data in the memory to provide the navigational function after the removal of the HDD 6.

Capacity of the memory in the controller 8 may be small compared to the high-capacity HDD 6. Therefore, the navigational function may be restricted to an extent in utilizing the navigational data in the memory in the controller 8.

Hereafter, the alternative HDD function and the corridor function are described with reference to the flowcharts. Prior to the use of the corridor function, the controller 8 executes a memory use amount setting process shown in FIG. 2 with the HDD 6 attached to the main body. The memory use amount setting process is for selecting (or setting) a use ratio of a memory amount used for the corridor function to the total amount of the memory in the controller 8.

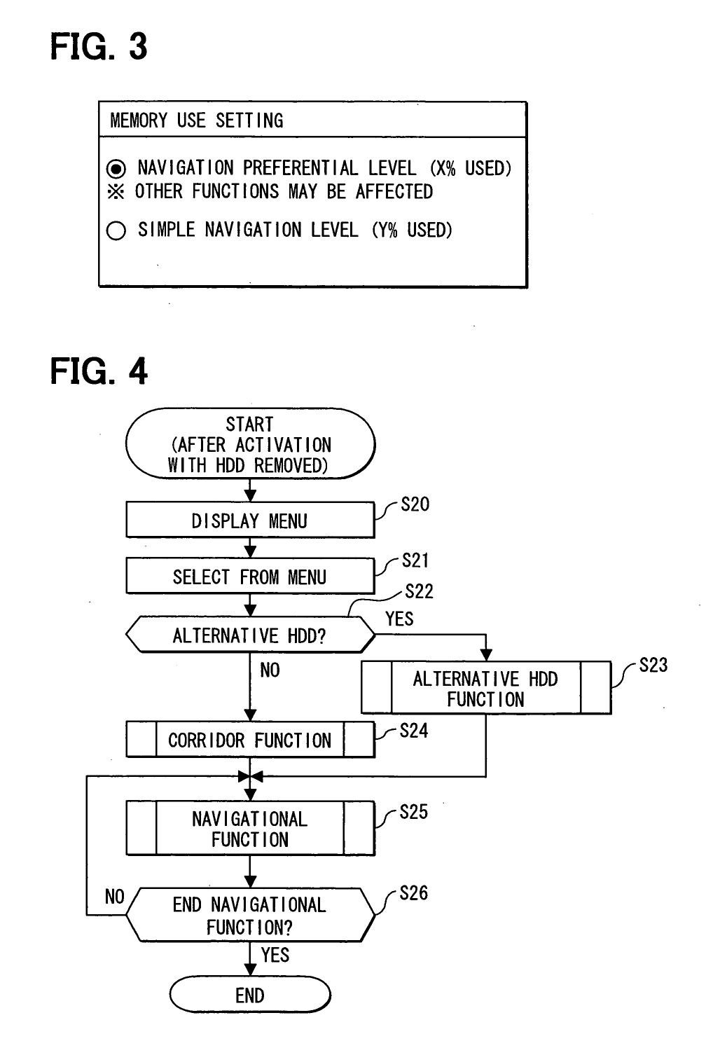

In Step S10 of the process in FIG. 2, the controller 8 causes the display 10 to display a memory use amount setting screen shown in FIG. 3. The use ratio includes a higher level (or higher use ratio) and a lower level (or lower use ratio). The higher level (i.e. a navigation preferential level) is for utilizing the navigational function preferentially compared to other functions, while the lower level (i.e. a simple navigation level) is for utilizing only simple parts of the navigational function.

Subsequently at Step S11, the controller 8 receives a selection of one of the two use ratios in the setting screen. Thus, the user can select whether to utilize the navigational function preferentially compared to other functions or to utilize the only simple parts of the navigational function.

As shown in FIG. 3, the controller 8 may cause the display 10 to put in the setting screen a message indicating that other functions may be adversely affected if the navigation preferential level is selected. Thus, even if a function other than the navigational function is restricted in using the corridor function, the restriction does not always make the user so uncomfortable to make a complaint, because the user is informed of the possibility of the restriction through the message. The message may contain the precise description of the specific restriction.

When the execution of the memory use amount setting process ends, the controller 8 of the HDD navigation device 100 reads the navigational data from the HDD 6 before the removal of the HDD 6, storing the navigational data into the memory in the controller 8.

Next, a process executed after an activation of the HDD navigation device 100 while the original HDD 6 being removed is described with reference to the flowchart in FIG. 4. First, when electrical power is supplied to the HDD navigation device 100, the controller 8 tries to access the HDD 6. When the access fails, the controller 8 executes steps in FIG. 4 to start the alternative HDD function and the corridor function. The starting of the functions corresponds to a determination that the HDD 6 has been removed.

Thus, the controller 8 determines a state of installation of the HDD 6 to the main body of the HDD navigation device 100 by trying to access the HDD 6. In addition, the HDD navigation device 100 activates the corridor function based on the determination that the HDD 6 has been removed. In other words, that the HDD 6 has been removed is a condition for activating the corridor function.

Therefore, the corridor function is not activated by an unintentional operation of the user to activate the corridor function while the HDD 6 is installed to the main body. As a result, it is possible to avoid unnecessary restrictions on the navigational function.

At Step S20 in FIG. 4, the controller 8 causes the display 10 to display a menu screen in the case that the HDD 6 has been removed. Subsequently at Step S21, the controller 8 receives a user's selection of one of two selection candidates in the menu. The first one of the selection candidates indicates the installation of an alternative HDD and the second one of the selection candidates indicates the utilization of the corridor function. Subsequently at Step S22, the controller 8 determines whether the first candidate is selected. If the determination at the Step S22 is affirmative, the controller 8 subsequently executes Step S23 to execute a process for the alternative HDD function. If the determination at the Step S22 is negative, the controller 8 subsequently executes Step S24 to execute a process for the corridor function.

Subsequently to Steps S23 or S24, a process for the navigational function is executed at Step S25. Subsequently at Step S26, the controller 8 determines whether the user has made an operation for terminating the navigational function. If the determination at the Step S26 is affirmative, the controller 8 subsequently ends the process in FIG. 4. If the determination at the Step S26 is negative, the controller 8 subsequently executes Step S25 to continue the process for the navigational function.

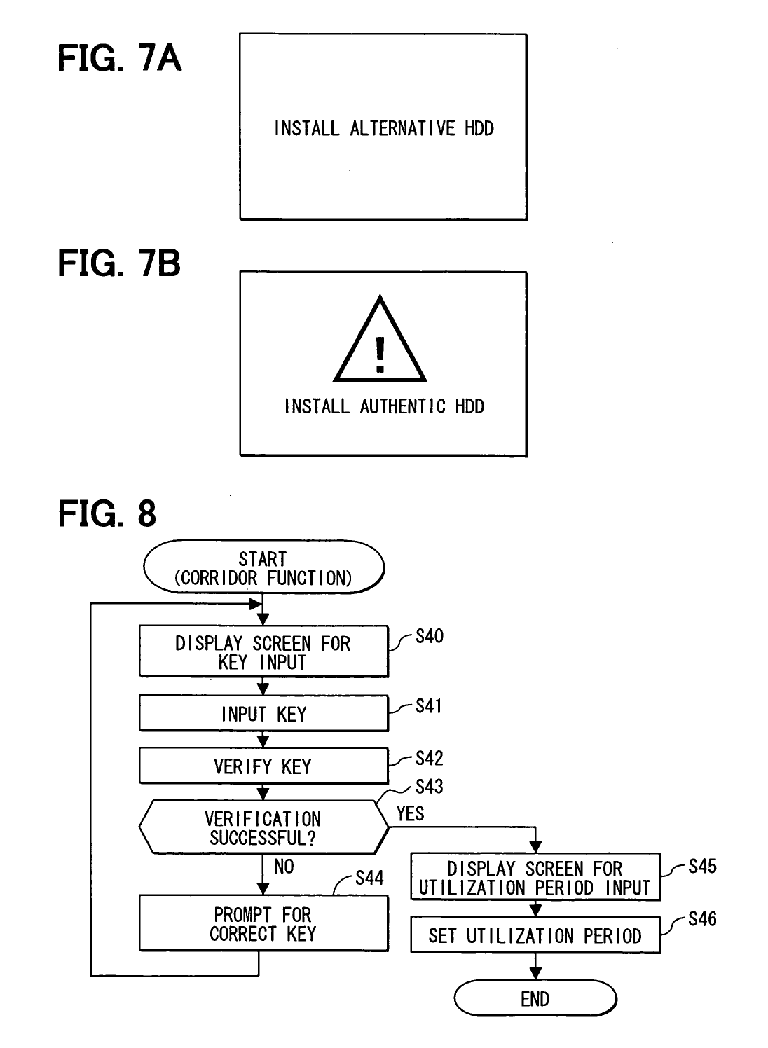

Next, the process for the alternative HDD function at Step S23 in FIG. 4 is described with reference to the flowchart in FIG. 6. At Step S30, the controller 8 first causes the display 10 to display, as shown in FIG. 7A, a screen for prompting installation of the alternative HDD and next determines whether the alternative HDD is installed (i.e. attached) to the main body. If the determination of Step S30 is affirmative, the controller 8 subsequently executes Step S31. If the determination of Step S30 is negative, the controller 8 waits until the alternative HDD is installed.

At Step S31, the controller 8 compares a first cipher code stored beforehand in the memory in the controller 8 with a second cipher code stored in the alternative HDD. In other words, the first and the second cipher codes are verified. Subsequently at Step S32, the controller 8 determines whether the first and second cipher codes satisfy a predetermined condition, that is, whether the verification is successful. If the determination at Step S32 is affirmative, the process for the alternative HDD function ends and the navigational function utilizing the navigational data in the alternative HDD is executed at Step S25 in FIG. 4. If the determination at Step S32 is negative, the controller 8 causes the display 10 to display, as shown in FIG. 7B, a screen prompting for installation of an authentic alternative HDD. Subsequently, the controller 8 executes Step S30 again to repeat the above operations.

Thus, in the HDD navigation device 100, the alternative HDD can be used while the original HDD 6 is removed from the main body, because the HDD 6 and the main body of the HDD navigation device 100 are constructed as separable devices.

When the alternative HDD is installed to the main body, the verification of the alternative HDD with the cipher codes is made before using the alternative HDD. When an HDD storing a false cipher code is installed to the main body, the false cipher code and the first cipher code in the memory in the controller 8 do not satisfy the predetermined condition. Therefore, it can be prohibited to use an unauthentic HDD as the alternative HDD.

It is possible to compose the navigational data and the second cipher code by using software dedicated for their composition provided by a manufacturer of the HDD navigation device 100. The manufacturer may distribute the software to the user when the user requests maintenance of the HDD 6.

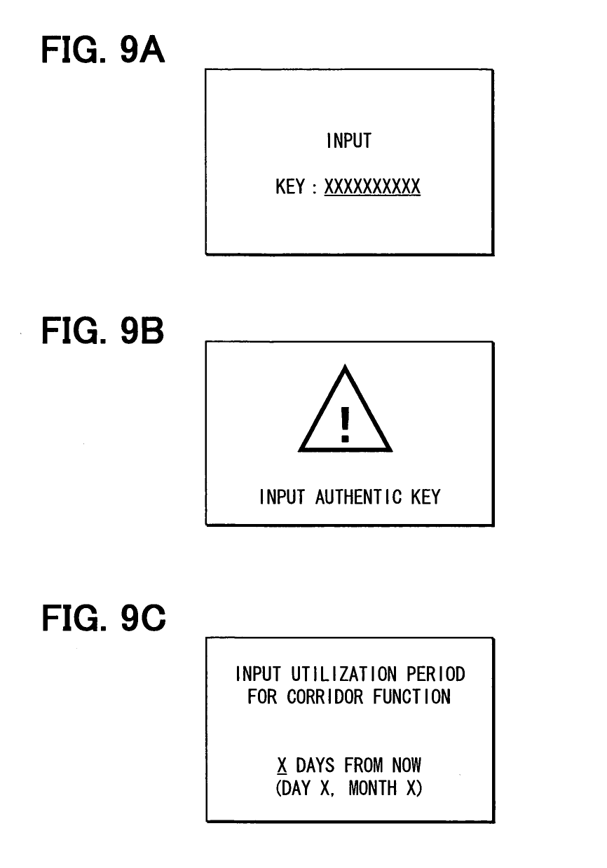

Next, the process for the corridor function at Step S24 in FIG. 4 is described with reference to FIG. 8. In the process, a first authentication key stored beforehand in the memory in the controller 8 is used for authentication. First, the controller 8 causes at Step S40 the display 10 to display, as shown in FIG. 9A, a screen for inputting an authentication key for utilizing the corridor function.

Subsequently at Step S41, the controller 8 receives a user's input of a second authentication key through the operation switches 7 or like. Subsequently at Step S42, the controller 8 verifies the first and second authentication keys. Subsequently at Step S43, the controller 8 determines whether the first and second authentication keys are identical. If the determination at Step S43 is affirmative, that is, the second authentication key is correct, the controller 8 subsequently executes Step S45.

If the determination at Step S43 is negative, the controller 8 subsequently causes at Step S44 the display 10 to display a screen prompting for a correct authentication key, as shown in FIG. 9B. Subsequently, the controller 8 executes Step S40 again to repeat the process for the corridor function.

Thus, the controller 8 verifies the authentication keys and activates the corridor function only if the first authentication key is identical with the second authentication key. In other words, it is a condition for activating the corridor function that the first authentication key is identical with the second authentication key. Therefore, it is possible to prevent the corridor function from being abused, because the corridor function is activated only if the condition is satisfied.

In addition, since it is a condition for activating the corridor function that the first authentication key stored beforehand and the second authentication key input by the user are identical, it is possible to prevent the corridor function from being abused for duplicating and falsifying while the HDD 6 is not attached to the main body. The correct authentication key may be supplied from the manufacturer of the HDD navigation device 100 to only legitimate or authorized users.

At Step S45, the controller 8 causes the display 10 to display, as shown in FIG. 9C, a screen for inputting (i.e. setting) a utilization period for the corridor function. The utilization period is a period after which the original HDD 6 is expected to be installed again to the main body. For example, the utilization period may be a period until the maintenance of the navigational data in the HDD 6 is finished. As shown in FIG. 9C, the screen includes a predetermined expiration period for the use of the corridor function. Subsequently at Step S46, the controller 8 receives the utilization period inputted through the operation switches 7 or like by the user. Thus, the utilization period for the corridor function can be set at user's will.

After the inputting and setting the utilization period, the corridor function becomes available for its use, and the controller 8 starts counting a number of continuous use days in which the corridor function is used. The number of the continuous use days is counted exactly by using the time information received by the GPS receiver 5.

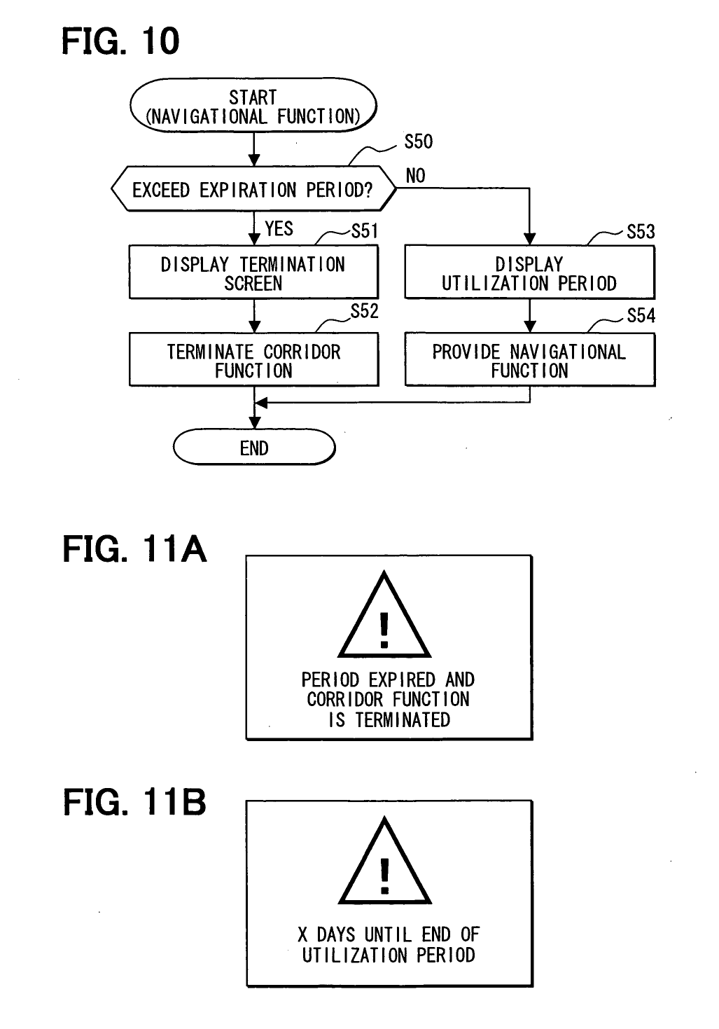

Next, the process for the navigational function at Step S25 in FIG. 4 is described with reference to FIG. 10. At Step S50 of FIG. 10, the controller 8 determines whether the counted number of the continuous use days exceeds the expiration period. If the determination of Step S50 is affirmative, the controller 8 subsequently executes Step S51. If the determination of Step S50 is negative, the controller 8 subsequently executes Step S53.

At Step S51, the controller 8 causes the display 10 to display a screen notifying of terminating the corridor function as shown in FIG. 11A, subsequently terminates at Step S52 the corridor function, and subsequently executes Step S20 of FIG. 4 again to display the menu screen.

As described above, it is a condition for making the corridor function available that the number of the continuous use days does not exceed the expiration period. When the condition is not satisfied, that is, when the number of the continuous use days exceeds the expiration period, the corridor function is terminated irrespective of the state of installation of the HDD 6 to prevent abuse of the corridor function. Thus, the HDD navigation device 100 helps the proper use of the corridor function.

At Step S53, the controller 8 causes the display 10 to display a screen indicating a number of remaining dates up to the end of the utilization period as shown in FIG. 11B. Thus, the user can recognize the period for which the navigational function is restricted because of operation of the corridor function.

In addition, the screen in FIG. 11B may be displayed when the HDD navigation device 100 is activated. In this case, the HDD navigation device 100 can inform of the corridor function being in operation to a user who did not practically experience the removal of the HDD 6 and therefore does not know that the HDD 6 has been removed.

Subsequently at Step S54, the controller 8 provides the navigational function by using the navigational data in the memory in the controller 8. Thus, the user can recognize the corridor function in operation by giving the information related to the utilization period for the corridor function.

Therefore, even if the basic parts of the navigational function are restricted in the HDD navigation device 100, the notification psychologically eases inconvenience caused by the restriction. As a result, it is possible to avoid making the user feel uncomfortable.

(Modifications)

The present invention should not be limited to the embodiment discussed above and shown in the figures, but may be implemented in various ways without departing from the spirit of the invention.

For example, at Step S43 in FIG. 8, the controller 8 may determine whether the first authentication key corresponds to the second authentication key. In this case, if the determination at Step S43 is affirmative, that is, the first authentication key is correct, the controller 8 subsequently executes Step S45. If the first authentication key and the second authentication key satisfy a predetermined relation for the authentication, it can be said that the first authentication key corresponds to the second authentication key.

Thus, the controller 8 verifies the authentication keys and activates the corridor function only if the first authentication key corresponds to the second authentication key. In other words, it is a condition for activating the corridor function that the first authentication key corresponds to the second authentication key.

Processes in the flowchart diagrams may be executed using a CPU, a ROM, and the like. Here, steps in the processes may be constructed as means or units in program stored in the ROM or the like.

What is claimed is:

1. A navigation device, comprising:
a control means for providing a corridor function for reading data for navigation before removal of an HDD from the navigation device, storing the read data for the navigation to a memory in a main body of the navigation device, and using the data stored in the memory for the navigation after the removal of the HDD; and
a notification means for giving information related to a utilization period for which the corridor function is used.

2. The navigation device according to claim 1, further comprising:
a setting means for setting the utilization period when the corridor function is used, wherein the information given by the notification means is related to the utilization period set by the setting means.

3. The navigation device according to claim 1, wherein the notification means gives the information when the navigation device is activated, and the given information is a remaining period up to an end of the utilization period.

4. The navigation device according to claim 1, further comprising:
a selection means for selecting one of multiple ratios as a ratio of a partial amount of the memory to a total amount of the memory when the corridor function is used,
wherein the memory is commonly used for the corridor function and another function provided by the navigation device, and
wherein the partial amount is used for the corridor function.

5. The navigation device according to claim 4, further comprising:
a warning means for informing when a given ratio is selected from the multiple ratios, wherein the given ratio is larger than a threshold causes an effect to the another function.

6. The navigation device according to claim 1, further comprising:
a key memorization means memorizing a first authentication key for the corridor function;
an input means for receiving an input of a second authentication key when the corridor function is used;
an authentication determination means for determining whether the first authentication key corresponds to the second authentication key; and
an instruction means for giving the control means an activating instruction that instructs the control means to activate the corridor function when the first authentication key is determined to correspond to the second authentication key,
wherein the control means activates the corridor function when the activating instruction is given by the instruction means.

7. The navigation device according to claim 6, further comprising:
an installation determination means for determining a state of installation of the HDD to the main body,
wherein the instruction means gives the control means the activating instruction when the first authentication key is determined to correspond to the second authentication key and simultaneously when the HDD is determined to be removed.

8. The navigation device according to claim 6, further comprising:
an expiration determination means for determining whether an expiration period has passed after when the corridor function is activated,
wherein:
the instruction means gives the control means the instruction when the first authentication key is determined to correspond to the second authentication key and simultaneously when the expiration period is determined not to have passed;
the instruction means gives the control means a deactivating instruction that instructs the control means to deactivate the corridor function when the expiration period is determined to have passed; and
the control means deactivates the corridor function when the deactivating instruction is given by the instruction means.

9. A navigation device, comprising:
a main body;
a certain HDD that is removable from the main body and stores data used for navigation;
an installation determination means for determining a state of installation of the certain HDD to the main body;
a code memorizing means for memorizing a first code for using an alternative HDD different from the certain HDD; and
a code determination means for determining whether the first code and a second code stored in the alternative HDD satisfy a predetermined condition,
wherein data stored in the alternative HDD is used for the navigation when the first code and the second code are determined to satisfy the predetermined condition.

10. A navigation device, comprising:
a control means for providing a corridor function for reading data for navigation before removal of an HDD from a main body of the navigation device, storing the read data for the navigation to a memory in the main body, and using the data stored in the memory for the navigation after the removal of the HDD;
a key memorization means for memorizing a first authentication key for the corridor function;
an input means for inputting a second authentication key when the corridor function is used;
an authentication determination means for determining whether the first authentication key corresponds to the second authentication key; and
an instruction means for giving the control means an activating instruction that instructs the control means to activate the corridor function when the first authentication key is determined to correspond to the second authentication key,
wherein the control means activates the corridor function when the activating instruction is given by the instruction means.

11. The navigation device according to claim 10, further comprising:
an installation determination means for determining a state of installation of the HDD to the main body,
wherein the instruction means gives the control means the activating instruction when the first authentication key is determined to correspond to the second authentication key and simultaneously when the HDD is determined to be removed.

12. The navigation device according to claim 10, further comprising:
an expiration determination means for determining whether an expiration period has passed after when the corridor function is activated,
wherein:
the instruction means gives the control means the instruction when the first authentication key is determined to correspond to the second authentication key and simultaneously when the expiration period is determined not to have passed;
the instruction means gives the control means a deactivating instruction that instructs the control means to deactivate the corridor function when expiration period is determined to have passed; and
the control means deactivates the corridor function when the deactivating instruction is given by the instruction means.

13. A navigation device, comprising:
an HDD storing data for navigation;
a memory other than the HDD; and
a controller for:
providing a corridor function for reading the data for the navigation before removal of the HDD from a main body of the navigation device, storing the read data for the navigation to the memory, and using the data stored in the memory for the navigation after the removal of the HDD; and
giving information related to a utilization period for which the corridor function is used.

14. A navigation device, comprising:
a main body;
a certain HDD that is removable from the main body and stores data for navigation; and
a controller for:
determining a state of installation of the certain HDD to the main body;
memorizing a first code for using an alternative HDD different from the certain HDD;
determining whether the first code and a second code stored in the alternative HDD satisfy a predetermined condition; and
using data stored in the alternative HDD for the navigation when the first code and the second code are determined to satisfy the predetermined condition.

15. A navigation device, comprising:
an HDD storing data for navigation;
a memory other than the HDD; and
a controller for:
providing a corridor function for reading the data for the navigation before removal of the HDD from a main body of the navigation device storing the read data for the navigation to the memory, and using the data stored in the memory for navigation after the removal of the HDD;
notifying information related to a utilization period for which the corridor function is used;
memorizing a first authentication key for the corridor function;
receiving a second authentication key when the corridor function is used;
determining whether the first authentication key corresponds to the second authentication key;
giving an activation instruction for activating the corridor function when the first authentication key is determined to correspond to the second authentication key.
